(19) United States
(12) Patent Application Publication
(10) Pub. No.: US 2023/0144644 A1
(43) Pub. Date: May 11, 2023

(54) COMPOSITE POSITIVE ACTIVE MATERIAL FOR LITHIUM SECONDARY BATTERY, METHOD OF PREPARING THE SAME, AND LITHIUM SECONDARY BATTERY INCLUDING POSITIVE ELECTRODE INCLUDING THE SAME

(71) Applicant: Samsung SDI Co., Ltd., Yongin-si (KR)

(72) Inventors: Youngki Kim, Yongin-si (KR); Yongmok Cho, Yongin-si (KR); Sungho Choo, Yongin-si (KR); Sangmi Kim, Yongin-si (KR); Minjae Choi, Yongin-si (KR); Jaeyoung Jeong, Yongin-si (KR); Hyunjei Chung, Yongin-si (KR)

(21) Appl. No.: 17/982,378

(22) Filed: Nov. 7, 2022

(30) Foreign Application Priority Data
Nov. 8, 2021 (KR) 10-2021-0152434

(51) Int. Cl. C01G 51/00; C01G 53/00

(52) U.S. Cl. CPC C01G 51/50; C01G 53/50; C01P 2006/40; C01P 2004/61

(57) ABSTRACT

A composite positive active material for a lithium secondary battery including a lithium cobalt-based oxide; a method of preparing the same; and a lithium secondary battery including a positive electrode for a lithium secondary battery including the composite positive active material are provided. The composite positive active material for a lithium secondary battery includes the lithium cobalt-based oxide, a particle coating part in a form of islands on one surface of the lithium cobalt-based oxide, the particle coating part including a first coating layer containing lithium titanium-based oxide, and a surface coating part in an internal region of another surface of the lithium cobalt-based oxide.

### CROSS-REFERENCE TO RELATED APPLICATION

This application claims priority to and the benefit of Korean Patent Application No. 10-2021-0152434, filed on Nov. 8, 2021, in the Korean Intellectual Property Office, the entire content of which is herein incorporated by reference.

### BACKGROUND

### 1. Field

One or more embodiments of the present disclosure relate to a composite positive active material for a lithium secondary battery, a method of preparing the same, and a lithium secondary battery including a positive electrode including the same.

### 2. Description of the Related Art

Recently, the use of portable electronic devices is increasing as development in the advanced electronics industry has enabled the miniaturization and weight reduction of electronic equipment. Lithium secondary batteries, which have high energy densities and long lifespans, are widely utilized as power sources of such portable electronic devices.

Lithium cobalt oxide (LiCoO₂) is widely utilized as a positive active material for high-density lithium secondary batteries. However, when lithium cobalt oxide is utilized as a positive active material, the positive active material is in contact with the electrolyte solution in the battery environment, and an interfacial structure may be destroyed due to corrosion by hydrofluoric acid (HF), especially at high temperatures, and as a result, cobalt (Co) may be eluted and the capacity of the lithium secondary battery may be reduced.

In order to prevent or reduce the collapse of the layered positive active material structure in a high voltage environment, aluminum is doped into lithium cobalt oxide.

However, when aluminum is doped in this way, high voltage characteristics do not reach a satisfactory level, and thus, improvement is necessary or desired.

### SUMMARY

Aspects of one or more embodiments of the present disclosure are directed towards providing a novel composite positive active material for a lithium secondary battery with improved stability and a manufacturing method thereof.

Aspects of one or more embodiments are directed towards providing a lithium secondary battery having improved stability at high voltages and having enhanced high-temperature characteristics by containing (e.g., including) a positive electrode including the composite positive active material for a lithium secondary battery.

Additional aspects will be set forth in part in the description which follows and, in part, will be apparent from the description, or may be learned by practice of the presented embodiments of the disclosure.

According to one or more embodiments of the present disclosure, a composite positive active material for a lithium secondary battery includes a lithium cobalt-based oxide particle coating part in a form of islands on one surface of the lithium cobalt-based oxide, the particle coating part including a first coating layer containing lithium titanium-based oxide, and a surface coating part in the internal region of another surface of the lithium cobalt-based oxide.

According to one or more embodiments of the present disclosure, a manufacturing method of the composite positive active material for a lithium secondary battery includes: mixing a lithium cobalt-based oxide, a titanium precursor, and cobalt hydroxide to obtain a first precursor mixture; performing a primary heat-treatment on the first precursor mixture to prepare a product of the primary heat-treatment; mixing the product of the primary heat-treatment and a zirconium precursor; and performing a secondary heat-treatment on the second precursor mixture to prepare the composite positive active material described above.

In one or more embodiments, an amount of the cobalt hydroxide is 1 part by weight to 3 parts by weight with respect to 100 parts by weight of the lithium cobalt-based oxide.

In one or more embodiments, an amount of the zirconium precursor is 0.2 parts by weight to 0.54 parts by weight with respect to 100 parts by weight of the lithium cobalt-based oxide.

In one or more embodiments, the zirconium precursor is zirconium oxide, and the titanium precursor is at least one of titanium hydroxide, titanium chloride, titanium sulfate, of titanium oxide.

In one or more embodiments, the heat treatment of the first precursor mixture is performed at 850° C. to 980° C.

In one or more embodiments, the heat treatment of the second precursor mixture is performed at 750° C. to 900° C.

According to one or more embodiments of the present disclosure, a lithium secondary battery includes: a positive electrode including the above-described composite positive active material; a negative electrode; and an electrolyte therebetween.

### BRIEF DESCRIPTION OF THE DRAWINGS

The above and other aspects, features, and/or principles of certain embodiments of the present disclosure will be more apparent based on the following description taken in conjunction with the accompanying drawings, in which:

FIG. 1A is a schematic diagram illustrating a structure of a composite positive active material according to one or more embodiments of the present disclosure;

FIG. 1B is a schematic diagram showing a structure of a composite positive active material according to one or more embodiments of the present disclosure;

FIGS. 2A-2F are images showing results from a scanning electron microscope-energy dispersive X-ray spectroscopy (SEM-EDS) analysis of the composite positive active material prepared according to Example 1;

FIG. 3 is a cross-sectional view schematically illustrating a structure of a lithium secondary battery according to one or more embodiments of the present disclosure; and

FIG. 4 is an image showing results from a high-resolution transmission electron microscopy (HR-TEM) analysis of the composite positive active material of Example 1.

### DETAILED DESCRIPTION

Reference will now be made in more detail to embodiments, embodiments of which are illustrated in the accompanying drawings, wherein like reference numerals refer to like elements throughout, and duplicative descriptions thereof may not be provided. In this regard, the present embodiments may have different forms and should not be construed as being limited to the descriptions set forth herein. Accordingly, the embodiments are merely described below, by referring to the drawings, to explain aspects of the present description. Accordingly, processes, elements, and techniques that are not necessary to those having ordinary skill in the art for a complete understanding of the aspects and features of the present disclosure may not be described.

In the drawings, the relative sizes of elements, layers, and regions may be exaggerated for clarity.

As used herein, the term “and/or” includes any and all combinations of one or more of the associated listed items. Expressions such as “at least one of,” when preceding a list of elements, modify the entire list of elements and do not modify the individual elements of the list. Expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and/or c,” “one selected from the group consisting of a, b, and c,” “at least one selected from a, b, and c,” “at least one from among a, b, and c,” “one from among a, b, and c”, “at least one of a to c” indicates only a, only b, only c, both (e.g., simultaneously) a and b, both (e.g., simultaneously) a and c, both (e.g., simultaneously) b and c, all of a, b, and c, or variations thereof.

Hereinafter, a composite positive active material, a method of preparing the same, and a lithium secondary battery including a positive electrode including the composite positive active material according to example embodiments will be described in more detail.

Lithium cobalt oxide (LiCoO₂) is a high-capacity positive active material and has a O3-type or kind layered structure in which lithium, cobalt, and oxygen are regularly arranged as O—Li—O—Co—O—Li—O—Co—O along the [111] crystal plane of the rock salt structure. When a lithium secondary battery having a positive electrode including such a lithium cobalt oxide is charged, lithium ions are deintercalated out of the lattice in the crystal lattice of the lithium cobalt oxide.

When a charging voltage of a lithium secondary battery increases, an amount of lithium ions deintercalating from the crystal lattice of the lithium cobalt oxide increases, and at least a part of the O3-type or kind layered structure may undergo a phase transition to a O1-type or kind layered structure (01 phase), in which Li does not exist in the crystal lattice. Accordingly, when a charging voltage is 4.52 V or more (based on a full cell), the lithium cobalt oxide may undergo a phase transition to a H1-3-type or kind layered structure (H1-3 phase), in which both (e.g., simultaneously) the O3-type or kind layered structure and the O1-type or kind layered structure are present in the crystal lattice of the lithium cobalt oxide. In this way, the phase transfer from the O3-type or kind layered structure to the H1-3-type or kind layered structure and the O1-type or kind layered structure is at least partially irreversible. And, in the H1-3-type or kind layered structure and the O1-type or kind layered structure, lithium ions that may be intercalated/deintercalated are reduced. When such a phase transition occurs, storage and lifespan characteristics of the lithium secondary battery are unavoidably rapidly deteriorated. In one or more embodiments, when a lithium cobalt oxide contacts an electrolyte solution, the interfacial structure may be destroyed due to corrosion by HF especially at high temperatures, resulting in elution of Co and reduction of battery capacity, and the structure of the positive active material having a layered structure in a high voltage environment may collapse.

In order to solve this problem, lithium cobalt oxide doped with aluminum and magnesium was proposed to be utilized as a positive active material. However, lithium secondary batteries adopting positive electrodes which use these positive active materials have high-voltage characteristics that do not reach a satisfactory level, and an improvement is needed or desired.

A composite positive active material according to one or more embodiments of the present disclosure was made to solve the above-described problems.

A composite positive active material according to one or more embodiments has a structure in which a particle coating part having a first coating layer containing a lithium titanium-based oxide is formed in a form of islands on a surface of a lithium cobalt-based oxide through the Mg—Ti Kirkendall effect, when magnesium of the lithium cobalt-based oxide moves to the surface when the lithium cobalt-based oxide having a certain amount of aluminum and magnesium reacts with titanium, zirconium and cobalt precursors.

A composite positive active material according to one or more embodiments has a particle coating part and a surface coating part, and thus, a reaction area between the composite positive active material and the electrolyte solution is reduced and side reactions are effectively suppressed or reduced.

A composite positive active material according to one or more embodiments is lithium cobalt-based oxide, a particle coating part may be arranged in a form of islands on one surface (that is, a first surface) of the lithium cobalt-based oxide, and a surface coating part may be arranged in a first internal region, which is arranged to contact the other surface (that is, a second surface) of the lithium cobalt-based oxide, or to be adjacent thereto.

A particle coating part includes a first coating layer containing lithium titanium-based oxide.

A second coating layer containing lithium zirconium-based oxide may be further included on the first coating layer. In one or more embodiments, the surface coating part may include a third coating layer which has a spinel crystal structure.

Lithium cobalt-based oxide according to one or more embodiments includes magnesium and aluminum. In the lithium cobalt-based oxide, an amount of aluminum (Al) is 4,000 ppm or more, for example, 4,000 ppm to 6,000 ppm. The content (e.g., amount) of aluminum is 1.5 mol % to 3.0 mol %, or 2.0 mol % to 2.5 mol %, with respect to the total metal excluding lithium in the core active material (at 100 mol %). As used herein, the ppm content (e.g., amount) of aluminum refers to the mass of aluminum with respect to a million of the mass of the entire positive active material.

When the aluminum content (e.g., amount) is in the aforementioned range, structural stability of the composite positive active material is improved and thus, a composite positive active material, in which high-voltage characteristics are improved, a reduction of a battery capacity is minimized or reduced, and an increase of resistance is minimized or reduced, may be obtained. In one or more embodiments, in the lithium cobalt-based oxide, an amount of magnesium (Mg) is 1,000 ppm or more, for example, 1,000 ppm to 1,500 ppm. The content (e.g., amount) of magnesium is 0.25 mol % to 0.7 mol % with respect to the total metal of the core active material. As used herein, the ppm content (e.g., amount) of magnesium refers to the mass of magnesium with respect to a million of the mass of the entire positive active material.

Even when an aluminum content (e.g., amount) in the composite positive active material is 4,000 ppm or more as described above, aluminum rarely spreads to the coating layer although Al content (e.g., amount) increases, and as Li sites are doped with a part of Al, an effect of structural stabilization of the composite positive active material may also be achieved. Therefore, the composite positive active material has excellent or suitable conductivity due to excellent or suitable high-temperature characteristics and improved surface resistance. Accordingly, such a composite positive active material has an enhanced structural stability of the crystal structure of the lithium cobalt-based oxide even under a high-temperature and high-voltage environment, and thus, a positive active material having excellent or suitable lifespan and storage characteristics and improved resistance characteristics may be implemented.

In this present disclosure, “high voltage” refers to a voltage in a range of 4.3 V to 4.8 V.

In a composite positive active material according to one or more embodiments, an amount of titanium may be 500 ppm to 800 ppm, and an amount of zirconium may be 2,100 ppm to 4,000 ppm. As used herein, the ppm content (e.g., amount) of titanium refers to the mass of titanium with respect to a million of the mass of the entire positive active material, and the ppm content (e.g., amount) of zirconium refers to the mass of zirconium with respect to a million of the mass of the entire positive active material.

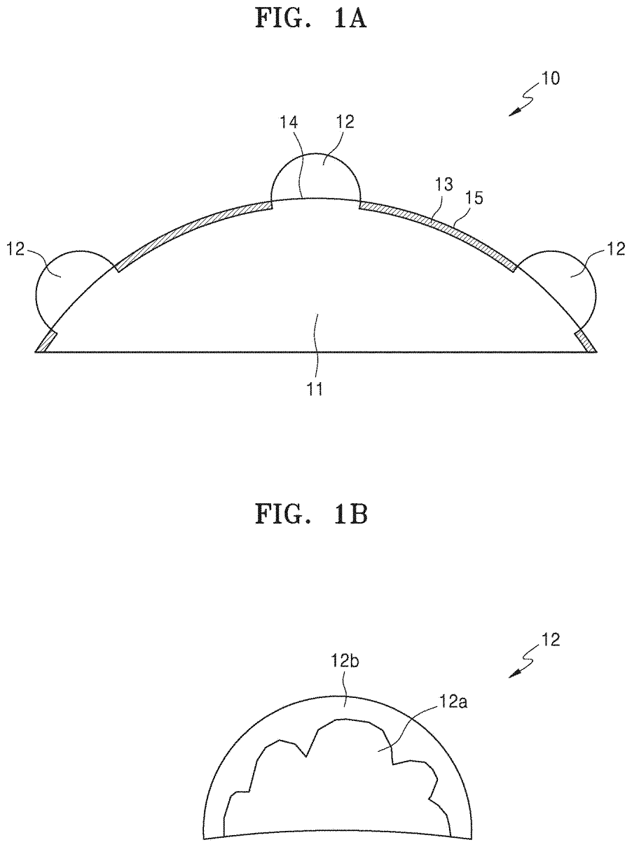

FIG. 1A schematically illustrates a structure of a composite positive active material according to one or more embodiments of the present disclosure.

Referring to FIG. 1A, the composite positive active material 10 may include a particle coating part 12 on at least one surface, i.e., a first surface 14 of lithium cobalt-based oxide 11 and a surface coating part 13 on at least one surface, i.e., a second surface 15 of a lithium cobalt-based oxide 11, and the particle coating part 12. The surface coating part 13 may have a layer form.

The particle coating part 12 contains a first coating layer 12a arranged to contact the lithium cobalt-based oxide as shown in FIG. 1B, and a second coating layer 12b arranged on the first coating layer 12a. The first coating layer contains a lithium titanium-based oxide, and the second coating layer contains a lithium zirconium-based oxide.

The particle coating part 12 has a semicircle (or semicircular) shape (e.g., a substantially semicircular shape) as in FIG. 1A, but is not limited thereto. When the particle coating part 12 is present in a form of islands, compared to a case when the particle coating part has a substantially continuous form, surface resistance of the composite positive active material is further improved. A size of the particle coating part may be 3.0 μm or less, for example, 0.5 μm to 3 μm. Here, a size of the particle coating part refers to the thickness, which may be measured by using a scanning electron microscope or a transmission electron microscope. In this specification, a “thickness” of the particle coating portion refers to a distance in a direction from an outer surface of the lithium cobalt oxide particle to an outer surface of the particle coating portion.

In an internal region contacting a second surface 15 of the lithium cobalt-based oxide 11 exists the surface coating part 13. The surface coating part 13 includes a third coating layer which has a spinel crystal structure. When the surface coating part 13 is present, high-temperature lifespan characteristics of the composite positive active material may be improved.

As used herein, the first surface 14 refers to one surface of the lithium cobalt-based oxide 11 on which the particle coating part 12 is formed as shown in FIG. 1A. And the second surface 15 refers to the other surface of the lithium cobalt-based oxide 11 on which the surface coating part 13 is formed.

In a composite positive active material according to one or more embodiments, lithium deficient cobalt oxide has a spinel crystal structure (Co₃O4 spinel phase (Fd-3m)).

Specific examples of the lithium deficient cobalt oxide include a compound represented by Formula 5, a compound represented by Formula 5-1, a compound represented by Formula 5-2, or a combination thereof.

Li_{1-α}MgₐCo₁₋ₓMₓO₂ Formula 5

In Formula 5, M is W, Mo, Zr, Ti, Mg, Ta, Al, Fe, V, Cr, Ba, Ca, Nb, or a combination thereof, 0.01≤α≤0.5, 0≤a≤0.05, and 0≤x≤0.05,

Li_{1-α}MgₐCo₂₋ₓMₓO₄ Formula 5-1

In Formula 5-1, M is W, Mo, Zr, Ti, Mg, Ta, Al, Fe, V, Cr, Ba, Ca, Nb, or a combination thereof, 0.01≤α≤0.5, 0≤a≤0.05, and 0≤x≤0.05,

Co₃₋ₓMₓO₄ Formula 5-2

In Formula 5-2, M is W, Mo, Zr, Ti, Mg, Ta, Al, Fe, V, Cr, Ba, Ca, Nb, or a combination thereof, and 0≤x≤0.05.

The lithium deficient cobalt oxide may include, for example, Li_{0.95}CoO₂, Li_{0.95}Co₂O₄, Li_{0.8}Mg_{0.007}CoO₂, or a combination thereof.

A thickness of a particle coating part 12 may be, for example, 100 nm to 500 nm.

According to one or more embodiments, a particle coating part 12 includes a first coating layer.

According to one or more embodiments, a particle coating part 12 has a structure in which a second coating layer 12b is arranged on a first coating layer 12a as shown in FIG. 1B, and the boundary of the first coating layer 12a and the second coating layer 12b may be formed unevenly. Referring to FIG. 1B, the boundary of the first coating layer 12a and the second coating layer 12b is uneven, but may be formed uniformly in some cases.

A thickness of the first coating layer 12a and the second coating layer 12b is variable, but, for example, the thickness of the first coating layer 12a is thicker than the thickness of the second coating layer 12b. A thickness of the first coating layer 12a is 100 nm to 500 nm, and a thickness of the second coating layer 12b is 100 nm to 300 nm. When a thickness of the first coating layer and the second coating layer is in the aforementioned range, a composite positive active material with improved surface resistance may be obtained.

The surface coating part 13 includes a third coating layer which has a spinel crystal structure. Here, a thickness of the third coating layer may be not more than 100 nm, for example, 10 nm to 100 nm. The third coating layer may contain, for example, lithium cobalt-based oxide A.

In this specification, a “thickness” of the particle coating portion refers to a distance in a direction from an outer surface of the lithium cobalt oxide particle to an outer surface of the particle coating portion. A thickness of the first coating layer refers to a distance in a direction from an outer surface of the lithium cobalt oxide particle to an outer surface of first coating layer. A thickness of the second coating layer refers to a distance from an outer surface of the first coating layer to an outer surface of the particle coating portion. A thickness of the third coating layer refers to a distance from an outer surface of the first coating layer to an inner surface of the third coating layer. Thickness can be determined by SEM or TEM analysis of a cross-section of a particle. Thickness may be determined by an average distance if the coating layer has an uneven thickness. In the Examples, the thickness can be determined by SEM or TEM analysis. An amount of the lithium titanium-based oxide in the particle coating part may be 0.05 parts by weight to 1.0 parts by weight with respect to 100 parts by weight of the lithium cobalt-based oxide, and an amount of the lithium zirconium-based oxide in the particle coating part may be 0.05 parts by weight to 0.2 parts by weight with respect to 100 parts by weight of the lithium cobalt-based oxide. When contents of the lithium titanium-based oxide and the lithium zirconium-based oxide are in the aforementioned range, a diffusion coefficient of a lithium ion increases and conductivity increases, so that a composite positive active material having a stabilized structure, in which side reactions with the electrolyte solution are suppressed or reduced, and elution of cobalt is suppressed or reduced, may be obtained.

An amount of lithium cobalt-based oxide A in the third coating layer of the surface coating part may be 0.01 of a part by weight to 1 part by weight with respect to 100 parts by weight of the lithium cobalt-based oxide. Lithium cobalt-based oxide A may be, for example, LiCo₂O₄, and when an amount of the lithium cobalt-based oxide A is in the aforementioned range, a composite positive active material with improved electrical conductivity may be obtained.

When contents of the lithium titanium-based oxide in the first coating layer, and an amount of the lithium zirconium-based oxide in the second coating layer in the particle coating part, and an amount of lithium cobalt-based oxide A in the surface coating part are within the aforementioned ranges, a diffusion coefficient of a lithium ion increases and electrical conductivity increases, and thus, a composite positive active material, having a stabilized structure, in which side reactions with the electrolyte solution are suppressed or reduced, may be prepared.

An example of the lithium titanium-based oxide in the first coating layer is a compound represented by Formula 1.

Li₂₊ₐTi_{(1-x-y)}CoₓMg_{y}O₃ Formula 1

In Formula 1, −0.1≤a≤1, 0≤x≤0.5, and 0<y≤0.1 and x may be, for example, 0.01 to 0.3, 0.01 to 0.2, 0.01 to 0.1 or 0.01 to 0.05, and y may be, for example, 0.01 to 0.08, 0.01 to 0.05 or 0.01 to 0.03.

The lithium titanium-based oxide may be, for example, Li₂Ti_{0.97}Co_{0.02}Mg_{0.01}O₃, etc.

An example of the lithium zirconium-based oxide in the second coating layer is a compound represented by Formula 2.

Li₂₊ₐZr_{(1-x-z)}Co_{z}M2ₓO₃ Formula 2

In Formula 2, M2 is at least one element including (e.g., selected from) boron (B), magnesium (Mg), calcium (Ca), strontium (Sr), barium (Ba), titanium (Ti), vanadium (V), chromium (Cr), iron (Fe), copper (Cu) and/or aluminum (Al), and −0.1≤a≤1, 0≤x<1, and 0≤z≤0.1.

In Formula 2, z is 0.01 to 0.1, 0.01 to 0.08, or 0.01 to 0.05.

An example of the lithium zirconium-based oxide may be Li₂Zr_{0.99}Co_{0.01}O₃, etc.

The lithium cobalt-based oxide has a R-3m rhombohedral layered structure.

And the lithium cobalt-based oxide may be, for example, a compound represented by Formula 3.

Li_{a-b}Mg_{b}Co_{(1-x-y-b)}AlₓM3_{y}O₂, Formula 3

In Formula 3, 0.9≤a≤1.1, 0≤b≤0.02, 0≤x≤0.04, and 0≤y≤0.01, and M3 is one of (e.g., one selected from) Ni, K, Na, Ca, Mg, Si, Fe, Cu, Zn, Ti, Sn, V, Ge, Ga, B, P, Se, Bi, As, Zr, Mn, Cr, Ge, Sr, V, Sc, Y, and/or a combination thereof.

An example of the lithium cobalt-based oxide may be a compound represented by Formula 4.

Li_{a-b}Mg_{b}Co_{(1-x-b)}AlₓO₂, Formula 4

In Formula 4, 0.9≤a≤1.1, 0.001≤b≤0.01, and 0.01<x≤0.03 and, a may be, for example, 0.9 to 1.05.

In Formulae 3 and 4, 0.015<x≤0.03 and 0.005≤b≤0.01.

A total thickness of a first coating layer and a second coating layer in a composite positive active material according to one or more embodiments may be 500 nm to 800 nm, and a thickness of a third coating layer may be not more than 100 nm, for example, 10 nm to 50 nm.

The second coating layer is arranged on the first coating layer, and the boundary between the first coating layer and the second coating layer may be even or uneven.

In a composite positive active material according to one or more embodiments, a ratio of the thickness of a first coating layer and the thickness of a second coating layer may be 1.1:1 to 1.5:1. Here, the ratio of the lengths of the long axis may be obtained through analyses utilizing a scanning electron microscope or a transmission electron microscope. As used herein, a thickness of the first coating layer refers to a distance in a direction from an outer surface of the lithium cobalt oxide particle to an outer surface of first coating layer. A thickness of the second coating layer refers to a distance from an outer surface of the first coating layer to an outer surface of the particle coating portion.

The lithium cobalt-based oxide may be, for example, small particles, large particles, or a mixture thereof.

A size (e.g., average size) of the large particles may be 10 μm to 20 μm, and a size (e.g., average size) of the small particles may be 3 μm to 6 μm. In one or more embodiments, a mixing weight ratio of large particles and small particles in the mixture of the large particles and the small particles may be 7:3 to 9:1, 8:2 to 9:1, or 5:1 to 7:1. When a mixing weight ratio of large particles and small particles is within the aforementioned range, a high-temperature lifespan and high-temperature storage characteristics are improved.

A size (e.g., average size) of the large particles may be 10 μm to 20 μm, 17 μm to 20 μm, or for example, 18 μm to 20 μm. And, a size (e.g., average size) of the small particles may be 3 μm to 6 μm, for example, 3 μm to 5 μm, or 3 μm to 4 μm.

In the present disclosure, a size (e.g., average size) of a particle is a particle diameter when the particles are spherical (e.g., substantially spherical), and a length of the long axis when the particle is non-spherical, such as plate-shaped or needle-shaped.

The particle diameter is, for example, an average particle diameter, and the length of the long axis is, for example, an average length of the long axis. The average particle diameter and the average length of the long axis indicates average values of the measured particle diameter and the measured length of the long axis, respectively.

A particle size may be identified by utilizing a particle size meter, a scanning electron microscope, or a transmission electron microscope. For example, an average particle diameter may be an average particle diameter observed by utilizing a scanning electron microscope (SEM). An average particle diameter may be calculated as an average particle diameter of about 10 to 30 particles by utilizing a SEM image. For example, an average particle diameter (when particles are spherical) or average major axis length (when particles are non-spherical) may be a median particle size or a D50 particle size. The term “D50” as used herein refers to the average diameter (or average major axis length) of particles whose cumulative volume corresponds to 50% by volume in the accumulated particle size distribution, unless otherwise defined herein. The term “D50” as used herein refers to a diameter (or major axis length) corresponding to 50% in the accumulated particle size distribution curve, when the total number of particles is 100% in the accumulated particle size distribution curve in which particles are sequentially accumulated in the order of a particle having the smallest size to a particle having the largest size. The average particle diameter (or average major axis length) D50 may be measured by utilizing one or more suitable methods available in the art such as, for example, a method utilizing a particle size analyzer (e.g., (HORIBA, LA-950 laser particle size analyzer), transmission electron microscopy (TEM), or scanning electron microscopy (SEM). Utilizing a TEM image or, for example, after a measurement apparatus utilizing dynamic light-scattering is utilized, data analysis may be performed to count the number of particles for each of the particle size ranges, which will provide the average particle diameter (or major axis length) D50 values. In the Examples, the average particle diameter is measured by using transmission electron microscopy (TEM), or scanning electron microscopy (SEM).

A composite positive active material according to one or more embodiments may have a layered crystal structure and a specific surface area may be 0.1 m²/g to 3 m²/g.

According to one or more embodiments of the present disclosure, a lithium secondary battery is provided including: a positive electrode including the composite positive active material; a negative electrode; and an electrolyte arranged therebetween.

Hereinafter, a preparation method of the composite positive active material according to one or more embodiments will be described in more detail.

In order to prepare a large-particle lithium cobalt-based oxide, a first mixture was obtained by mixing a cobalt precursor of a particle size of 4 μm to 7 μm, a lithium precursor and a metal precursor.

For example, a first mixture of precursors may be obtained by mixing while a mixing ratio of a lithium precursor, a cobalt precursor, and a metal precursor was stoichiometrically controlled or selected in order to obtain the lithium cobalt-based oxide represented by Formula 3.

Li_{a-b}Mg_{b}Co_{(1-x-y-b)}AlₓM3_{y}O₂ Formula 3

In Formula 3, 0.9≤a≤1.1, 0≤b≤0.02, 0≤x≤0.04, and 0≤y≤0.01, and M3 is one of (e.g., one selected from) Ni, K, Na, Ca, Mg, Si, Fe, Cu, Zn, Ti, Sn, V, Ge, Ga, B, P, Se, Bi, As, Zr, Mn, Cr, Ge, Sr, V, Sc, Y, and/or a combination thereof.

The metal precursor may be at least one of (e.g., one selected from), for example, a magnesium precursor, an aluminum precursor, and/or an M3 precursor.

As a lithium precursor, at least one of (e.g., one selected from) lithium hydroxide (LiOH), lithium carbonate (LiCO₃), lithium chloride, lithium sulfate (Li₂SO₄), and/or lithium nitrate may be utilized. As a cobalt precursor, at least one of (e.g., one selected from) cobalt carbonate, cobalt hydroxide, cobalt chloride, cobalt sulfate, and/or cobalt nitrate may be utilized.

As an aluminum precursor, at least one of (e.g., one selected from) aluminum sulfate, aluminum chloride, and/or aluminum hydroxide may be utilized, and as a magnesium precursor, at least one of (e.g., one selected from) magnesium sulfate, magnesium chloride, and/or magnesium hydroxide may be utilized.

For the mixing, a dry mixing such as a mechanical mixing may be performed by utilizing a ball mill, a Banbury mixer, a homogenizer, or a Hensel mixer. A dry mixing may reduce manufacturing costs compared to a wet mixing.

A particle size of a cobalt precursor utilized in preparing the first mixture may be 4 μm to 7 μm or 4 μm to 6.0 μm. When the particle size of the cobalt precursor is less than 4 μm or more than 7 μm, it is difficult to obtain the large-particle lithium cobalt-based oxide having a desired or suitable size.

Subsequently, by performing a primary heat-treatment on the first mixture in the air or under an oxygen atmosphere, large-particle lithium cobalt composite oxide may be obtained. The primary heat-treatment is performed at 800° C. to 1,100° C.

A particle size of the large-particle lithium cobalt-based oxide may be 10 μm to 20 μm, 17 μm to 20 μm, for example, 18 μm to 20 μm, for example, 19 μm.

Separately, in order to prepare small-particle lithium cobalt-based oxide, a second mixture was obtained by mixing a cobalt precursor of a particle size of 2 μm to 3 μm, a lithium precursor and a metal precursor. Here, the metal precursor may be the same as the metal precursor described when manufacturing the first mixture.

By performing a primary heat-treatment on the second mixture, small-particle lithium cobalt composite oxide is prepared. The primary heat-treatment is performed at 800° C. to 1,000° C.

A particle size of the small-particle lithium cobalt-based oxide may be 3 μm to 6 μm, 3 μm to 5 μm, for example, 3 μm to 4 μm.

When a size of the cobalt precursor utilized in preparing small-particle lithium cobalt-based oxide is less than 2 μm or more than 3 μm, it is difficult to obtain the small-particle lithium cobalt-based oxide having a desired or suitable size.

When preparing the large-particle lithium cobalt-based oxide and the small-particle lithium cobalt-based oxide, a mixing ratio (Li/Me) of lithium and metals (Me) other than lithium in the lithium cobalt-based oxide may be 0.9 to 1.1, 1.01 to 1.05, 1.02 to 1.04, 1.02 to 1.03, 022 to 1.028, or 1.023 to 1.026.

In preparing the large-particle lithium cobalt composite oxide and the small-particle lithium cobalt composite oxide, a heating rate is 4° C./min to 6° C./min. When a heating rate is within the range, positive ions may be prevented or substantially prevented from mixing in. When a heating rate is below 4° C./min, phase stability improvement at a high voltage is minimal. A molar ratio of lithium and the metal other than lithium may be 1.01 to 1.05, 1.01 to 1.04, 1.02 to 1.03, 1.02 to 1.03, or 1.04.

The above-described large-particle lithium cobalt-based oxide and the small-particle lithium cobalt-based oxide are mixed at a weight ratio of 7:3 to 1:9, and a first precursor mixture is obtained by mixing in a titanium precursor and cobalt hydroxide, and a heat-treatment is performed thereto.

An amount of the cobalt hydroxide is 1 part by weight to 3 parts by weight with respect to 100 parts by weight of the lithium cobalt-based oxide. When an amount of the cobalt hydroxide is within the aforementioned range, a desired or suitable composite positive active material may be obtained.

The heat treatment is performed at 850° C. to 980° C., and a heating rate is 2° C./min to 10° C./min, or 4° C./min to 6° C./min. When a heating rate is within the aforementioned range, a spinel structure may be formed on the surface coating part.

The heat-treatment may be performed in the air or under an oxygen atmosphere. Here, the oxygen atmosphere may be formed by utilizing oxygen alone, or by utilizing oxygen and inert gases such as nitrogen.

A second precursor mixture is obtained by mixing the product heat-treated according to the above process and a zirconium precursor, and a heat-treatment is performed on the second precursor mixture. The heat-treatment of the second precursor mixture is performed at 750° C. to 900° C. A heating rate is 2° C./min to 10° C./min, or for example, 4° C./min to 6° C./min. When a heating rate is within the aforementioned range, surface characteristics of the composite positive active material may be controlled or selected as desired or suitable.

An example of a titanium precursor may be, titanium oxide, titanium hydroxide, titanium chloride, or a combination thereof. Cobalt hydroxide has an excellent or suitable chemical reactivity compared to cobalt oxide. When utilizing cobalt oxide as a cobalt precursor, because the particle size of the cobalt oxide is large, a coating layer in a form of islands may be formed, and a coating layer according to one or more embodiments may not be formed.

Cobalt hydroxide having an average particle diameter of 50 nm to 300 nm or 100 nm to 200 nm is utilized. By utilizing cobalt hydroxide having such a size, a composite positive active material which has a coating layer according to one or more embodiments may be obtained.

An amount of the cobalt hydroxide may be 1 part by weight to 3 parts by weight or 1.5 parts by weight to 2.5 parts by weight with respect to 100 parts by weight of the lithium cobalt-based oxide. And, an amount of the zirconium precursor may be 0.2 parts by weight to 0.54 parts by weight with respect to 100 parts by weight of the lithium cobalt-based oxide.

A zirconium precursor may be zirconium oxide, zirconium hydroxide, zirconium chloride, zirconium sulfate, or a combination thereof.

A molar ratio of lithium and the metal other than lithium in the precursor mixture before performing the heat-treatment is controlled or selected to be 0.99 to 1. When a molar ratio of lithium and the metal other than lithium is in the above-described range, a lithium cobalt composite oxide with improved high-voltage phase stability may be prepared.

A composite positive active material according to one or more embodiments may be prepared according to a general manufacturing method such as a spray pyrolysis method apart from the solid processing method.

According to one or more embodiments of the present disclosure, a positive electrode including the lithium cobalt composite oxide is provided.

According to one or more embodiments of the present disclosure, a lithium secondary battery including the positive electrode is provided. A manufacturing method of the lithium secondary battery is as follows.

A positive electrode is prepared according to the following method.

A positive active material composition, in which a composite positive active material according to one or more embodiments, a binder, and a solvent are mixed, is prepared. A conductive agent may be further included in the positive active material composition. A positive electrode plate is prepared by directly coating the positive active material composition on a metal current collector and drying. In one or more embodiments, the positive active material composition may be casted on a separate support, and then a film peeled off from the support may be laminated on the positive electrode current collector to prepare a positive electrode plate. A first positive active material which is a positive active material generally utilized in a lithium secondary battery may be further included in preparing the positive electrode. At least one of (e.g., one selected from) lithium cobalt oxide, lithium nickel cobalt manganese oxide, lithium nickel cobalt aluminum oxide, lithium iron phosphate, and/or lithium manganese oxide may be further included as the first positive active material, but the first positive active material is not limited thereto, and all that may be utilized as a positive active material in the art may be utilized. For example, a compound represented by any one of the following formulae may be utilized: LiₐA_{1-b}B_{b}D₂ (wherein, 0.90≤a≤1.8, and 0≤b≤0.5); LiₐE_{1-b}B_{b}O_{2-c}D_{c} (wherein, 0.90≤a≤1.8, 0≤b≤0.5, and 0≤c≤0.05); LiE_{2-b}B_{b}O_{4-c}D_{c} (wherein, 0≤b≤0.5, and 0≤c≤0.05); LiₐNi_{1-b-c}Co_{b}B_{c}D_{α} (wherein, 0.90≤a≤1.8, 0≤b≤0.5, ≤c≤0.05, and 0<α≤2); LiₐNi_{1-b-c}Co_{b}B_{c}O_{2-α}F_{α} (wherein, 0.90≤a≤1.80≤b≤0.5, 0≤c≤0.05, and 0<α<2); LiₐNi_{1-b-c}Mn_{b}B_{c}D_{α} (wherein, 0.90≤a≤1.8, 0≤b≤0.5, 0≤c≤0.05, and 0<α≤2); LiₐNi_{1-b-c}Mn_{b}B_{c}O_{2-α}F_{α} (wherein, 0.90≤a≤1.8, 0≤b≤0.5, 0≤c≤0.05, and 0<α<2); LiₐNi_{b}E_{c}G_{d}O₂ (wherein, 0.90≤a≤1.8, 0≤b≤0.9, 0≤c≤0.5, and 0.001≤d≤0.1); LiₐNi_{b}Co_{c}Mn_{d}GeO₂ (wherein, 0.90≤a≤1.8, 0≤b≤0.9, 0≤c≤0.5, 0≤d≤0.5, and 0.001≤e≤0.1); LiₐNiG_{b}O₂ (wherein, 0.90≤a≤1.8, and 0.001≤b≤0.1); LiₐCoG_{b}O₂ (wherein, 0.90≤a≤1.8, 0.001≤b≤0.1); LiₐMnG_{b}O₂ (wherein, 0.90≤a≤1.8, and 0.001≤b≤0.1); LiₐMn₂G_{b}O₄ (wherein, 0.90≤a≤1.8, 0.001≤b≤0.1); QO₂; QS₂; LiQS₂; V₂O₅; LiV₂O₅; LiIO₂; LiNiVO₄; Li_{(3-f)}(PO₄)₃ (0≤f≤2); Li_{(3-f)}Fe₂(PO₄)₃ (0≤f≤2); and LiFePO₄. In the formulae above, A is Ni, Co, Mn, or a combination thereof; B is Al, Ni, Co, Mn, Cr, Fe, Mg, Sr, V, a rare earth element, or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu, or a combination thereof.

In the positive active material composition, a binder may be polyvinylidene fluoride (PVDF), vinylidene fluoride-hexafluoropropylene copolymer (PVDF-co-HFP), polyvinyl alcohol, polyacrylonitrile, carboxymethyl cellulose (CMC), starch, hydroxypropyl cellulose, regenerated cellulose, polyvinylpyrrolidone, tetrafluoroethylene, polyethylene, polypropylene, ethylene-propylene-diene polymer (EPDM), sulfonated-EPDM, styrene-butadiene rubber (SBR), fluororubber, polyamideimide, polyacrylic acid (PAA), and/or other one or more suitable copolymers.

The conductive agent is not particularly limited as long as the conductive agent does not cause a chemical change in the battery and has conductivity (e.g., is a conductor) and is, for example, graphite such as natural graphite or artificial graphite; carbon-based materials such as carbon black, acetylene black, ketjen black, channel black, furnace black, lamp black, and summer black; conductive fibers such as carbon nanotubes, carbon fibers, and/or metal fibers; carbon fluoride; metal powders such as aluminum powder and nickel powder; conductive whiskers such as zinc oxide and potassium titanate; conductive metal oxides such as titanium oxide; and/or conductive materials such as a polyphenylene derivative.

An amount of 1 part by weight to 10 parts by weight, or 1 part by weight to 5 parts by weight of the conductive agent may be utilized. When an amount of the conductive agent is in the aforementioned range, the ultimately obtained electrode has excellent or suitable conductivity characteristics.

As a non-limiting example of the solvent, N-methyl pyrrolidone and/or the like may be utilized, and an amount of the solvent utilized may be 20 parts by weight to 200 parts by weight with respect to 100 parts by weight of the positive active material. When an amount of the solvent is in the range, the process to form a positive active material layer may be easily performed.

A thickness of the positive electrode current collector is 3 μm to 500 μm, and the positive electrode current collector is not particularly limited within that range as long as the positive electrode current collector does not cause a chemical change in the battery and has conductivity (e.g., is a conductor) and is, for example, stainless steel, aluminum, nickel, titanium, heat-treated carbon, or aluminum or stainless steel surface-treated with carbon, nickel, titanium, silver, etc. The positive electrode current collector may increase adhesion of the positive active material by forming fine irregularities on its surface, and one or more suitable forms such as a film, a sheet, a foil, a net, a porous body, a foam, and/or a nonwoven fabric are possible.

On the other hand, it is also possible to form pores inside the electrode by further adding a plasticizer to the positive active material composition and/or the negative active material composition.

Contents of the positive active material, the conductive agent, the binder, and the solvent are levels generally utilized in lithium secondary batteries. Depending on the utilization and configuration of the lithium secondary battery, one or more of the conductive material, binder, and solvent may not be provided.

A negative electrode may be obtained by utilizing an almost identical method, except that a negative active material is utilized instead of a positive active material in the process for manufacturing a positive electrode.

As a negative active material, a carbon-based material, silicon, silicon oxide, a silicon-based alloy, a silicon carbon-based material complex, tin, a tin-based alloy, metal oxide, or a combination thereof, may be utilized.

The carbon-based material may be crystalline carbon, amorphous carbon or a mixture thereof. The crystalline carbon may be graphite such as amorphous, plate-like, flake-like, spherical (e.g., substantially spherical) or fibrous natural graphite, or artificial graphite, and the amorphous carbon may be soft carbon (carbon calcined at a low temperature) or hard carbon, mesophase pitch carbide, calcined cokes, graphene, carbon black, carbon nanotube, and/or carbon fiber, but is not necessarily limited to thereto and all that may be utilized in the art may be utilized.

For the negative active material, one of (e.g., one selected from) Si, SiOx (0<x<2, for example, x may be 0.5 to 1.5), Sn, SnO₂, a silicon-containing metal alloy, and/or a mixture thereof may be utilized. For the metal capable of forming the silicon alloy, at least one of (e.g., one selected from) Al, Sn, Ag, Fe, Bi, Mg, Zn, In, Ge, Pb, and/or Ti may be utilized.

The negative active material may include metals/metalloids that may be alloyed with lithium, an alloy thereof, or an oxide thereof. For example, the metal/metalloid that may be alloyed with lithium may be Si, Sn, Al, Ge, Pb, Bi, Sb, Si—Y alloy (wherein Y is an alkali metal, an alkaline earth metal, a group 13 element, a group 14 element (excluding Si), a transition metal, a rare earth element, or a combination thereof), Sn—Y alloy (wherein Y is an alkali metal, an alkaline earth metal, a group 13 element, a group 14 element (excluding Sn), a transition metal, a rare earth element, or a combination thereof), MnOx (0<x≤2), and/or the like. The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, or a combination thereof. For example, the oxide of the metal/metalloid that may be alloyed with lithium may be lithium titanium oxide, vanadium oxide, lithium vanadium oxide, SnO₂, SiOₓ (0<x<2), etc.

The negative active material may include, for example, at least one of (e.g., one selected from) group 13 elements, group 14 elements, and/or group 15 elements in the periodic table of elements, specifically, at least one of (e.g., one selected from) Si, Ge, and/or Sn.

In a negative active material composition, a water-insoluble binder, a water-soluble binder, or a combination thereof may be utilized as a binder.

As the non-water-soluble binder, ethylene propylene copolymer, polyacrylonitrile, polystyrene, polyvinyl chloride, carboxylated polyvinyl chloride, polyvinyl fluoride, Polyurethane, polytetrafluoroethylene, polyvinylidene fluoride, polyethylene, polypropylene, polyamideimide, polyimide, or a combination thereof may be utilized.

As the water-soluble binder, styrene-butadiene rubber (SBR), acrylated styrene-butadiene rubber (ABR), acrylonitrile-butadiene rubber, acrylic rubber, butyl rubber, fluororubber, ethylene oxide-containing polymer, polyvinylpyrrolidone, Polyepichlorohydrin, polyphosphazene, ethylene propylene diene copolymer, polyvinylpyridine, chlorosulfonated polyethylene, latex, polyester resin, acrylic resin, phenol resin, epoxy resin, polyvinyl alcohol, or a combination thereof may be utilized.

When a water-soluble binder is utilized as the negative electrode binder, a cellulose-based compound capable of giving viscosity may be further included as a thickener. As the cellulose-based compound, one or more of carboxymethyl cellulose, hydroxypropylmethyl cellulose, methyl cellulose, or a alkali metal salt thereof may be mixed to be utilized. As the alkali metal, Na, K, or Li may be utilized. An amount of the thickener may be 0.1 of a part by weight to 3 parts by weight with respect to 100 parts by weight of the negative active material.

As the conductive agent, carbon materials such as natural graphite, artificial graphite, carbon black, acetylene black, ketjen black, and/or carbon fiber; metal-based materials such as metal powder of copper, nickel, aluminum, silver, or a metal fiber; conductive polymers such as a polyphenylene derivative; or a mixture thereof may be utilized.

In the negative active material composition, the solvent may be the same as that utilized in the positive active material composition. And an amount of the solvent is a level generally utilized in lithium secondary batteries.

A separator is interposed between the positive electrode and the negative electrode, and an insulating thin film having high ionic transmittance and mechanical strength is utilized.

A diameter of the pore of the separator is generally 0.01 μm to 10 μm, and a thickness of the separator is generally 5 μm to 20 μm. As such a separator, for example, an olefin polymer such as polypropylene; sheets and/or nonwoven fabrics made of glass fibers or polyethylene are utilized. When a solid polymer electrolyte is utilized as an electrolyte, the solid polymer electrolyte may also be a separator.

In an example of an olefin polymer in the separator, polyethylene, polypropylene, polyvinylidene fluoride, or a multilayer film of two or more layers thereof may be utilized, and a mixed multilayer film such as a polyethylene/polypropylene two-layer separator, a polyethylene/polypropylene/polyethylene three-layer separator, a polypropylene/polyethylene/polypropylene three-layer separator and/or the like may be utilized.

The non-aqueous electrolyte containing a lithium salt is composed of a non-aqueous electrolyte and a lithium salt.

As the non-aqueous electrolyte, a non-aqueous electrolyte, an organic solid electrolyte, or an inorganic solid electrolyte is utilized.

The non-aqueous electrolyte solution includes an organic solvent. For the organic solvent, all that may be utilized as an organic solvent in the art may be utilized. The organic solvent may be, for example, propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, fluoroethylene carbonate, benzonitrile, acetonitrile, tetrahydrofuran, 2-methyltetrahydrofuran, γ-butyrolactone, dioxolane, 4-methyldioxolane, N,N-dimethylformamide, N,N-dimethylacetamide, dimethyl sulfoxide, dioxane, 1,2-dimethoxyethane, sulfolane, dichloroethane, chlorobenzene, nitrobenzene, diethylene glycol, dimethyl ether, or a mixture thereof.

As the organic solid electrolyte, for example, polyethylene derivatives, polyethylene oxide derivatives, polypropylene oxide derivatives, phosphoric acid ester polymers, polyvinyl alcohol, and/or the like may be utilized.

As the inorganic solid electrolyte, for example, Li₃N, LiI, Li₅NI₂, Li₃N—LiI—LiOH, Li₂SiS₃, Li₄SiO₄, Li₄SiO₄—LiI—LiOH, Li₃PO₄—Li₂S—SiS₂, and/or the like may be utilized.

The lithium salt is a material that dissolves well in the non-aqueous electrolyte, and is for example, LiPF₆, LiBF₄, LiSbF₆, LiAsF₆, LiClO₄, LiCF₃SO₃, Li(CF₃SO₂)₂N, Li(FSO₂)₂N, LiC₄F₉SO₃, LiAlO₂, LiAlCl₄, LiN(CₓF₂ₓ₊₁SO₂)(C_{y}F_{2y+1}SO₂) (wherein x, y are natural numbers), LiCl, LiI, or a mixture thereof. In one or more embodiments, in order to improve charge/discharge characteristics, flame retardancy, etc., for example, pyridine, triethylphosphite, triethanolamine, cyclic ether, ethylene diamine, n-glyme, hexamethyl phosphoramide, nitrobenzene derivatives, sulfur, quinone imine dyes, N-substituted oxazolidinone, N, N-substituted imidazolidine, ethylene glycol dialkyl ether, ammonium salts, pyrrole, 2-methoxyethanol, aluminum trichloride, etc. may be added. In some cases, halogen-containing solvents such as carbon tetrachloride, ethylene trifluoride, etc. may be further included to give incombustibility. A preferred concentration of a lithium salt is in the range of 0.1 M to 2.0 M. When a concentration of a lithium salt is included in this range, the electrolyte has an appropriate or suitable conductivity and viscosity, and an excellent or suitable electrolyte performance may be exhibited, and lithium ions may move effectively.

The lithium secondary battery includes a positive electrode, a negative electrode, and a separator.

The positive electrode, the negative electrode, and the separator are winded or folded to be enclosed in a battery case. Next, an organic electrolyte solution is injected into the battery case, then the battery case is sealed with a cap assembly, and a lithium battery is completed. The battery case may have a cylindrical shape, a rectangular shape, or a thin film shape.

A separator may be arranged between the positive electrode and the negative electrode to form a battery structure. When the battery structure is impregnated with an organic electrolyte, and accommodated in a pouch and sealed, a lithium ion polymer battery is completed.

In one or more embodiments, a plurality of the battery structures may be laminated to form a battery pack, and such a battery pack may be utilized for all devices that require high capacity and high power. For example, the battery pack may be utilized in a laptop, a smartphone, an electric vehicle, etc.

A lithium secondary battery according to one or more embodiments which is given as an example is a rectangular shape, but the present disclosure is not limited thereto and may be applied to batteries of one or more suitable shapes such as a cylindrical shape, a pouch shape, or a coin shape.

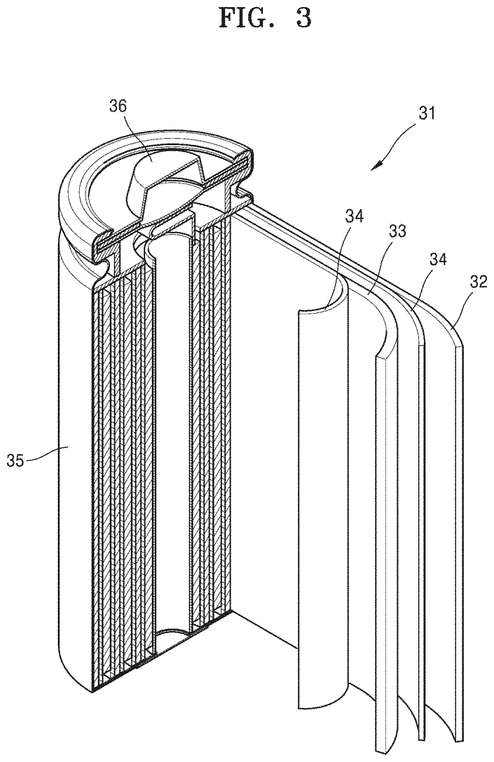

FIG. 3 is a cross-sectional view schematically illustrating a representative structure of a lithium secondary battery according to one or more embodiments of the present disclosure.

Referring to FIG. 3, a lithium secondary battery 31 includes a positive electrode 33, a negative electrode 32, and a separator 34. The above-described positive electrode 33, negative electrode 32, and separator 34 are winded or folded to be enclosed in the battery case 35. A separator is interposed between the positive electrode and the negative electrode according to the shape of the battery and an alternately laminated battery structure may be formed. Next, an organic electrolyte solution is injected into the battery case 35, then the battery case 5 is sealed with a cap assembly 86, and a lithium secondary battery is completed. The battery case 35 may have a cylindrical shape, a rectangular shape, or a thin film shape. For example, the lithium secondary battery 31 may be a large thin-film battery. The lithium secondary battery may be a lithium-ion battery. When the battery structure is enclosed in a pouch, impregnated with an organic electrolyte solution and sealed, a lithium ion polymer battery is completed. In one or more embodiments, a plurality of the battery structures may be laminated to form a battery pack, and such a battery pack may be utilized for all devices that require high capacity and high power. For example, the battery pack may be utilized in a laptop, a smartphone, an electric vehicle, etc.

The present disclosure will be described in more detail through the following examples and comparative examples. However, the examples are intended to illustrate the present disclosure, and the scope of the present disclosure is not limited thereto.

### Preparation of Composite Positive Active Material

### Example 1: LCO Doped with 1,000 ppm of Mg and 4,000 ppm of Al (1.45 Mol %)+Surface Coating of Ti 700 ppm/Zr 2,250 ppm

A first mixture was obtained by mixing lithium carbonate, Co₃O₄ (D50: 4.5 μm), aluminum hydroxide Al(OH)₃, and magnesium carbonate as a magnesium precursor. After heating the first mixture at a heating rate of 4.5° C./min to 1088° C., a primary heat-treatment was performed on the first mixture at the temperature for 15 hours under an air atmosphere, and large particles of Li_{1.025}Mg_{0.001}Co_{0.985}Al_{0.015}O₂ having a layered structure and an average particle diameter (D50) of about 17 μm were prepared. Here, a molar ratio of lithium to metal excluding lithium (Li/Me) was 1.025. The metal Me indicates cobalt and aluminum. The metal Me indicates represents the sum of metal elements excluding lithium.

Separately, a second mixture was obtained by mixing Co₃O₄ (D50: 2.5 μm), which is a cobalt precursor, aluminum hydroxide Al(OH)₃, lithium carbonate, and magnesium carbonate, which is a magnesium precursor, and the second mixture was heated at a heating rate of 4.5° C./min to 940° C., and a heat treatment was performed at the temperature for 5 hours, and small particles of Li_{1.025}Mg_{0.001}Co_{0.985}Al_{0.015}O₂ (D50: 3.5 μm) having a layered structure were obtained. Here, a molar ratio of lithium per a metal (Li/Me) was 1.025. The metal Me indicates represents the sum of metal elements excluding lithium.

After mixing the large particles and the small particles obtained in the process at a weight ratio of 8:2, titanium oxide and cobalt hydroxide (Co(OH)₂) (average particle diameter: about 100 nm) were added, and a third mixture was obtained.

The third mixture was heat-treated at about 950° C. Here, an amount of the cobalt hydroxide is 2 parts by weight with respect to 100 parts by weight of the large particles or the small particles, and an amount of titanium oxide was stoichiometrically controlled or selected so that an amount of titanium was about 700 ppm in the composite positive active material.

Subsequently, zirconium oxide was added to the heat-treated product to obtain a fourth mixture, and the fourth mixture was heat-treated at about 850° C. Here, an amount of the zirconium oxide was stoichiometrically controlled or selected so that an amount of zirconium was about 2250 ppm in the composite positive active material.

Through the heat-treatment, a bimodal composite positive active material containing large particles of Li_{1.025}Mg_{0.001}Co_{0.985}Al_{0.015}O₂ (D50: 17 μm) and small particles of Li_{1.025}Mg_{0.001}Co_{0.985}Al_{0.015}O₂ (D50: 3.5 μm), in which a first coating layer and a third coating layer are arranged on the surface, and a second coating layer is arranged on the first coating layer, was obtained. In addition, the first coating layer contains Li₂Ti_{0.97}Co_{0.02}Mg_{0.01}O₃, the second coating layer contains Li₂Zr_{1.98}Co_{0.02}O₃, and the third coating layer contains LiCo₂O₄.

### Example 2: LCO Doped with 1,000 ppm of Mg and 6,000 ppm of Al (2.17 Mol %)+Surface Coating with Ti 700 ppm/Zr 2,250 ppm

A composite positive active material was prepared in substantially the same manner as in Example 1, except that Li_{1.025}Mg_{0.001}Co_{0.978}Al_{0.022}O₂ (D50: 17 μm) and Li_{1.025}Mg_{0.001}Co_{0.978}Al_{0.022}O₂ (D50: 3.5 μm) were utilized as large particles and small particles, respectively.

### Example 3

A composite positive active material was prepared in substantially the same manner as in Example 1, except that an amount of zirconium oxide in the fourth mixture was changed so that an amount of zirconium in the composite positive active material may be about 4,000 ppm.

### Comparative Example 1: LCO Doped with 1,000 ppm of Mg [Nanoparticles Co(OH)₂ Coating Layer]

A large-particle and small-particle composite positive active material was prepared in substantially the same manner as in Example 2, except that aluminum hydroxide is not added when preparing the first mixture and the second mixture.

After mixing the large particles and the small particles obtained in the process at a weight ratio of 8:2, cobalt hydroxide (Co(OH)₂) was added, and a third mixture was obtained. A secondary heat-treatment was performed on the third mixture at about 900° C., and a bimodal composite positive active material was obtained.

### Comparative Example 2: LCO Doped with 4,000 ppm of Al (1.45 Mol %) [Nanoparticles Co(OH)₂ Coating]

A large-particle and small-particle composite positive active material was prepared in substantially the same manner as in Example 1, except that magnesium carbonate is not added when preparing the first mixture and the second mixture.

After mixing the large particles and the small particles obtained in the process at a weight ratio of 8:2, cobalt hydroxide (Co(OH)₂) was added, and a third mixture was obtained. A secondary heat-treatment was performed on the third mixture at about 900° C., and a bimodal composite positive active material was obtained.

### Comparative Example 3: LCO Doped with 1,000 ppm of Mg and 4,000 ppm of Al (1.45 Mol %)

A large-particle and small-particle composite positive active material was prepared in substantially the same manner as in Example 1, except that amounts of lithium carbonate, Co₃O₄, aluminum hydroxide Al(OH)₃ and MgCO₃, which is a magnesium precursor, were stoichiometrically controlled or selected in preparing the first mixture and the second mixture, in order to obtain Li_{1.025}Mg_{0.005}Co_{0.985}Al_{0.015}O₂.

After mixing the large particles and the small particles obtained in the process at a weight ratio of 8:2, cobalt hydroxide (Co(OH)₂) was added, and a third mixture was obtained. A secondary heat-treatment was performed on the third mixture at about 900° C., and a bimodal composite positive active material containing the large particles of Li_{1.025}Mg_{0.005}Co_{0.985}Al_{0.015}O₂ (D50: 17 μm) and the small particles of Li_{1.025}Mg_{0.005}Co_{0.985}Al_{0.015}O₂ (D50: 3.5 μm) was obtained.

### Comparative Example 4: LCO Doped with 1,000 ppm of Mg and 4,000 ppm of Al (1.45 Mol %)+Surface Coating Layer with Ti 700 ppm [Nanoparticles Co(OH)₂ Coating)

After mixing the large particles and the small particles obtained according to Example 1 at a weight ratio of 8:2, titanium oxide and cobalt hydroxide (Co(OH)₂) were added, and a third mixture was obtained. The bimodal composite positive active material was prepared in substantially the same manner as in Example 1, except that the third mixture was heat-treated to about 950° C., addition of zirconium oxide and further heat-treatment were not performed on the heat-treated product.

### Preparation of Lithium Secondary Battery

### Manufacture Example 1

A mixture of the aluminum hydroxide Al(OH)₃ positive active material obtained according to Example 1, polyvinylidene fluoride, and carbon black as a conductive agent was subjected to mixing by utilizing a mixer to remove air bubbles to prepare a uniformly dispersed slurry for forming a aluminum hydroxide Al(OH)₃ positive active material layer. A solvent of N-methyl 2-pyrrolidone was added to the mixture, and a mixing ratio of the composite positive active material, the polyvinylidene fluoride, and the carbon black was prepared at a weight ratio of 98:1:1. The slurry prepared according to this process was coated on a thin film of aluminum by utilizing a doctor's blade to make a thin electrode plate, and the plate was dried at 135° C. for 3 hours or more, and then a positive electrode was prepared through rolling and vacuum drying processes.

For the negative electrode, a composition for forming a negative active material was obtained by mixing natural graphite, carboxymethylcellulose (CMC), and styrene butadiene rubber (SBR), and the negative active material composition was coated on a copper current collector and dried to prepare a negative electrode. A weight ratio of the natural graphite, CMC, and SBR was 97.5:1:1.5, and an amount of distilled water was about 50 parts by weight with respect to 100 parts by weight of the total weight of the natural graphite, CMC, and SBR.

A separator (thickness: about 10 μm) consisting of a porous polyethylene (PE) film was interposed between the positive electrode and the negative electrode, and an electrolyte solution was injected to prepare a lithium secondary battery. The electrolyte was a solution of 1.1 M LiPF₆ dissolved in a mixed solvent of ethylene carbonate (EC), ethyl methyl carbonate (EMC), and dimethyl carbonate (DMC) in a volume ratio of 3:4:3.

### Manufacture Example 2 to 6

Lithium secondary batteries were prepared in substantially the same manner as in Manufacture Example 1, except that each of composite positive active materials of Examples 2 to 6 was prepared instead of the positive active material of Example 1 when preparing a positive electrode.

### Comparative Manufacture Example 1 to 4

A lithium secondary battery was prepared in substantially the same manner as in Manufacture Example 1, except that each of composite positive active materials of Comparative Examples 1 to 4 was prepared instead of the composite positive active material of Example 1 when preparing a positive electrode.

### Evaluation Example 1: Charge/Discharge Characteristics

A lithium secondary battery was charged at a constant current at 25° C. until a state of charge (SOC) of 90% was reached, aging proceeded for 48 hours, and in a constant current/constant voltage mode, while maintaining a voltage of 4.58 V, the battery was cut off at a current of 0.05 C rate. Subsequently, the battery was discharged at a constant current of 0.5 C rate until the voltage reached 3.0 V (formation process).

The lithium secondary battery that went through the formation process was charged at a constant current of 0.2 C until the voltage reached 4.55 V. After the charging is completed in the battery, there was a rest period of about 10 minutes, and the battery was discharged at a constant current of 0.2 C until the voltage reached 3 V.

Initial charge/discharge efficiency was evaluated according to Equation 1 and the evaluation results are shown in Table 1.

Initial charge/discharge efficiency (%)=(discharge capacity (0.2 C) at the first cycle/charge capacity (0.2 C) at the first cycle)×100 <Equation 1>

### Evaluation Example 2: High-Temperature Characteristics

A lithium secondary battery was charged at a constant current at 45° C. until a state of charge (SOC) of 90% was reached, aging proceeded for 48 hours, and in a constant current/constant voltage mode, while maintaining a voltage of 4.58 V, the battery was cut off at a current of 0.05 C rate. Subsequently, the battery was discharged at a constant current of 0.5 C rate until the voltage reached 3.0 V (formation process, 1st cycle).

The lithium secondary battery that went through the 1st cycle of the formation process was charged at 45° C. at a constant current of 0.2 C until the voltage reached 4.55 V. After the charging was completed in the battery, there was a rest period of about 10 minutes, and then the battery was discharged at a constant current of 0.2 C until the voltage reached 3 V; and the cycle was repeatedly performed for 50 times for an evaluation.

High-temperature lifespans were evaluated according to Equation 2 and the evaluation results are shown in Table 1.

Lifespan (%)=(discharge capacity at the 50th cycle/charge capacity at the first cycle)×100 <Equation 2>

### Evaluation Example 3: Direct Current-Resistance (DC-IR) Test

The lithium secondary batteries prepared in Manufacture Examples 1 to 3 and Comparative Manufacture Examples 1 to 4 were charged at a constant current at 25° C. until a state of charge (SOC) of 90% was reached, aging proceeded for 48 hours, and in a constant current/constant voltage mode, while maintaining a voltage of 4.58 V, the battery was cut off at a current of 0.05 C rate. Subsequently, the batteries were discharged at a constant current of 0.5 C rate until the voltage reached 3.0 V (formation process).

The lithium secondary batteries that went through the formation process were charged at a constant current of 0.2 C until the voltage reached 4.55 V. After the charging was completed in the batteries, there was a rest period of about 10 minutes, and the batteries were discharged at a constant current of 0.2 C until the voltage reached 3 V.

Direct current-resistances (DC-IR) of the lithium secondary batteries that went through the processes were measured, and the results are shown in Table 1:

TABLE 1

| | | | | Comparative | Comparative | Comparative | Comparative |
|---|---|---|---|---|---|---|---|
| | Manufacture | Manufacture | Manufacture | Manufacture | Manufacture | Manufacture | Manufacture |
| Coin cell | Example 1 | Example 2 | Example 3 | Example 1 | Example 2 | Example 3 | Example 4 |
| 0.2 C charge capacity | 208.1 | 208.1 | 208.1 | 212.2 | 210.1 | 209.4 | 209.5 |
| (mAh) | | | | | | | |
| 0.2 C discharge | 192.5 | 192.5 | 192.5 | 206.3 | 197.9 | 195.8 | 195.7 |
| capacity (mAh) | | | | | | | |
| 0.2 C charge/discharge | 92.5 | 92.5 | 92.1 | 97.2 | 94.2 | 93.5 | 93.4 |
| efficiency (%) | | | | | | | |
| High-temperature | 63.2 | 75.1 | 80.4 | 20.2 | 48.5 | 52.6 | 47.5 |
| lifespan (%) (@ 50th | | | | | | | |
| cycle) | | | | | | | |
| DCIR (mΩ) | 11.0 | 10.5 | 9.4 | 20.2 | 18.2 | 18.3 | 13.2 |

Referring to Table 1, lithium secondary batteries of Manufacture Examples 1 to 3 have significantly improved high-temperature lifespan and enhanced resistance characteristics compared to lithium secondary batteries of Comparative Manufacture Examples 1 to 4.

In addition, charge/discharge efficiency, high-temperature lifespan and DC-IR characteristics of lithium secondary batteries of Manufacture Examples 4 to 6 were evaluated in substantially the same manner as in evaluating charge/discharge efficiency, high-temperature lifespan and DC-IR characteristics of the lithium secondary battery of Manufacture Example 1 as described above.

As results of the evaluation, lithium secondary batteries of Manufacture Examples 4 to 6 showed equally excellent or suitable levels of charge/discharge efficiency, high-temperature lifespan and DC-IR characteristics as the lithium secondary battery of Manufacture Example 1.

### Evaluation Example 4: SEM-EDS Analysis

A Scanning electron microscope-energy dispersive X-ray spectroscopy (SEM-EDS) analysis was performed on the composite positive active material prepared according to Example 1. For the SEM-EDS, a Spectra 300 (Thermo Fisher) was utilized.

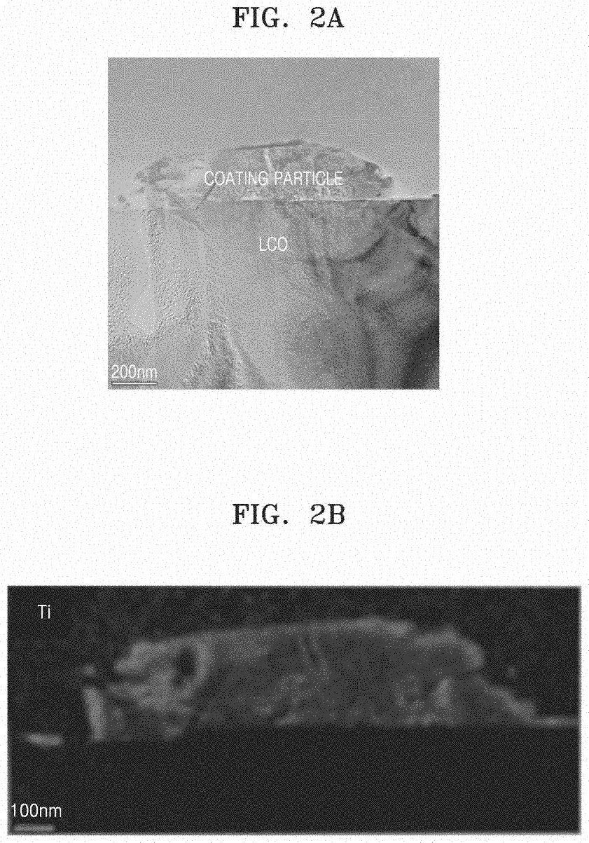

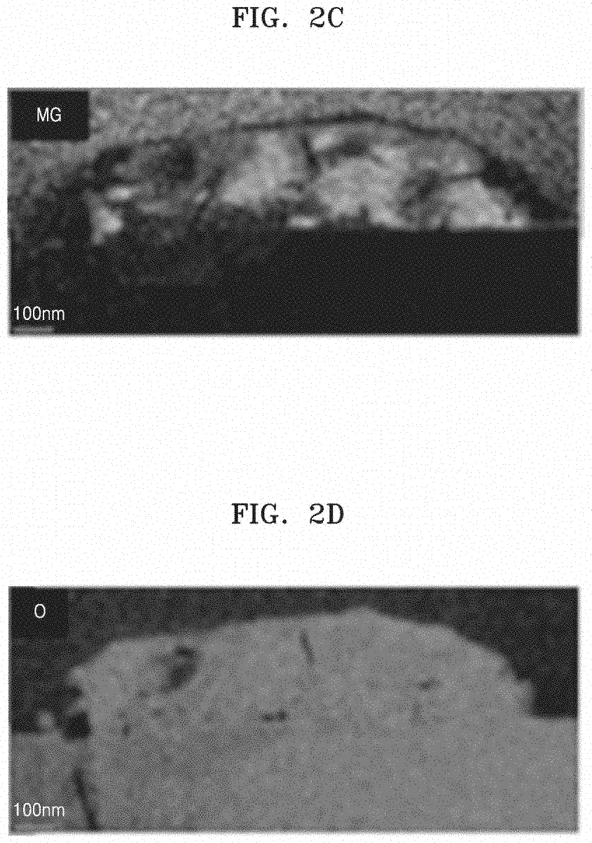

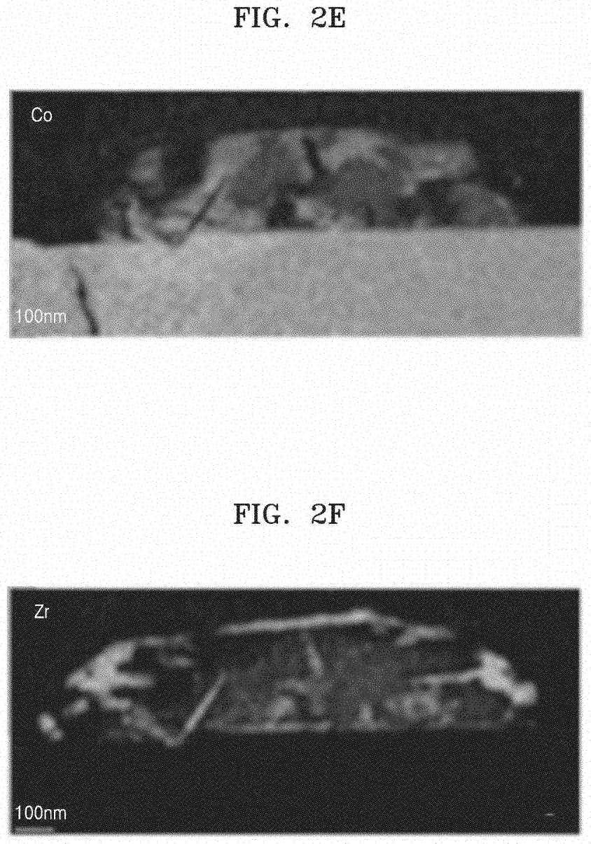

The SEM-EDS analysis results are shown in FIGS. 2A to 2F. FIG. 2A shows a region measured by an EDS mapping. FIG. 2B is an image of Ti mapping, FIG. 2C is an image of Mg mapping, FIG. 2D is an image of O mapping, FIG. 2E is an image of Co mapping, and FIG. 2F is an image of Zr mapping.

Referring to these, the core region of the composite positive active material and a region where coating particles are formed indicate that Co components are evenly present, Mg components appear in the region where the coating particles are formed, and Zr and Ti components appear in the particle coating region. It may be seen that O components are evenly distributed both (e.g., simultaneously) in the core region and the coating particle region.

### Evaluation Example 5: High-Resolution Transmission Electron Microscopy (HR-TEM)

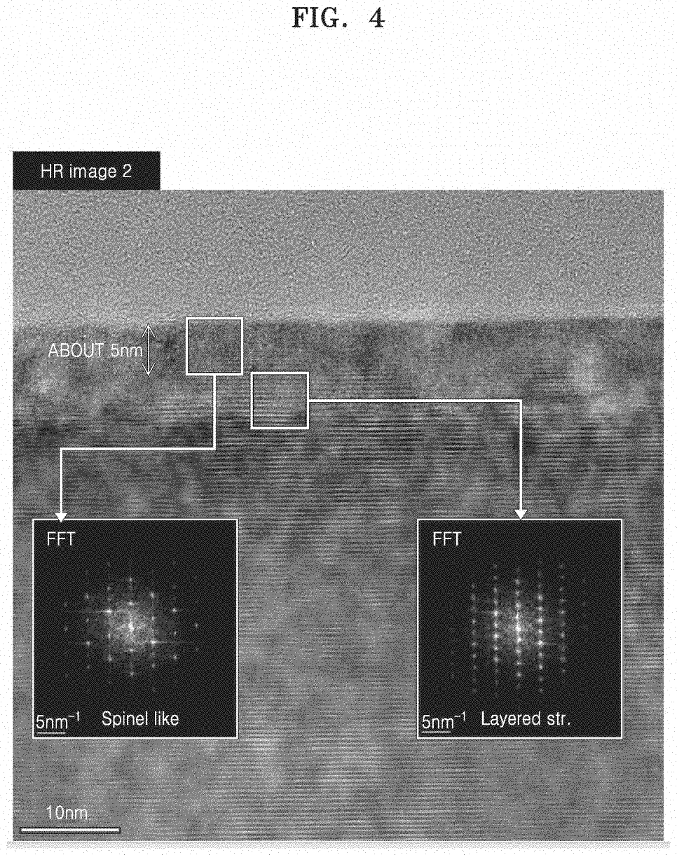

A high-resolution transmission electron microscopy (HR-TEM) analysis was performed on the composite positive active material of Example 1, and the analysis results are shown in FIG. 4.

As results of the analysis, it may be seen that LiCo₂O₄ having a spinel structure is formed on a surface of the core active material particle having a layered structure (R-3m) in the composite positive active material of Example 1.

A composite positive active material according to one or more embodiments has an effect of suppressing phase transition on the surface and may suppress or reduce side reactions with the electrolyte solution on the surface.

A lithium secondary battery with improved high-voltage characteristics may be prepared by applying a positive electrode including such a composite positive active material. It should be understood that embodiments described herein should be considered in a descriptive sense only and not for purposes of limitation.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

In the present disclosure, when particles are spherical, “diameter” indicates a particle diameter or an average particle diameter, and when the particles are non-spherical, the “diameter” indicates a major axis length or an average major axis length. The diameter (or size) of the particles may be measured utilizing a scanning electron microscope or a particle size analyzer. As the particle size analyzer, for example, HORIBA, LA-950 laser particle size analyzer, may be utilized. When the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

It will be understood that when an element or layer is referred to as being “on,” another element or layer, it can be directly on the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

As used herein, the singular forms “a,” “an” and “the” are intended to include the plural forms as well, unless the context clearly indicates otherwise.

It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

As used herein, the term “substantially,” “about,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within ±30%, 20%, 10%, 5% of the stated value.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Further, the use of “may” when describing embodiments of the present disclosure refers to “one or more embodiments of the present disclosure.”

The portable device, vehicle, and/or the battery, e.g., a battery controller, and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

Descriptions of features or aspects within each embodiment should typically be considered as available for other similar features or aspects in other embodiments. While one or more embodiments have been described with reference to the drawings, it will be understood by those of ordinary skill in the art that one or more suitable changes in form and details may be made herein without departing from the spirit and scope of the disclosure as defined by the following claims and equivalents thereof.

What is claimed is:

1. A composite positive active material for a lithium secondary battery, the composite position active material comprising:
a lithium cobalt-based oxide,
a particle coating part in a form of islands on one surface of the lithium cobalt-based oxide, the particle coating part comprising a first coating layer containing a lithium titanium-based oxide, and
a surface coating part in an internal region of another surface of the lithium cobalt-based oxide.

2. The composite positive active material of claim 1, wherein an amount of aluminum in the lithium cobalt-based oxide is 4,000 ppm or more, and an amount of magnesium in the lithium cobalt-based oxide is 1,000 ppm or more.

3. The composite positive active material of claim 1, wherein the lithium titanium-based oxide is a compound represented by Formula 1:
Li₂₊ₐTi_{(1-x-y)}CoₓMg_{y}O₃, Formula 1
wherein, in Formula 1, −0.1≤a≤0.1, 0<x≤0.5, and 0<y≤0.1.

4. The composite positive active material of claim 1, wherein the particle coating part further comprises a second coating layer, and the second coating layer is on the first coating layer and comprises lithium zirconium-based oxide.

5. The composite positive active material of claim 4, wherein the lithium zirconium-based oxide is a compound represented by Formula 2:
Li₂₊ₐZr_{(1-x-z)}Co_{z}M2ₓO₃, Formula 2
wherein, in Formula 2, M2 is at least one element of boron (B), magnesium (Mg), calcium (Ca), strontium (Sr), barium (Ba), titanium (Ti), vanadium (V), chromium (Cr), iron (Fe), copper (Cu) or aluminum (Al), and −0.1≤a≤0.1, 0≤x<1, and 0≤z≤0.1.

6. The composite positive active material of claim 1, wherein the surface coating part comprises a lithium cobalt-based oxide A.

7. The composite positive active material of claim 6, wherein an amount of the lithium cobalt-based oxide A is 0.01 parts by weight to 1 part by weight with respect to 100 parts by weight of the lithium cobalt-based oxide.

8. The composite positive active material of claim 1, wherein the lithium cobalt-based oxide is a compound represented by Formula 3:
Li_{a-b}Mg_{b}Co_{(1-x-y-b)}AlₓM3_{y}O₂, Formula 3
wherein, in Formula 3, 0.9≤a≤1.1, 0≤b≤0.02, 0≤x≤0.04, and 0≤y≤0.01, and M3 is one of Ni, K, Na, Ca, Mg, Si, Fe, Cu, Zn, Ti, Sn, V, Ge, Ga, B, P, Se, Bi, As, Zr, Mn, Cr, Ge, Sr, V, Sc, Y, or a combination thereof.

9. The composite positive active material of claim 1, wherein in the particle coating part, an amount of the lithium titanium-based oxide is 0.05 parts by weight to 1.0 parts by weight with respect to 100 parts by weight of the lithium cobalt-based oxide.

10. The composite positive active material of claim 4, wherein in the particle coating part, an amount of the lithium zirconium-based oxide is 0.05 parts by weight to 0.2 parts by weight with respect to 100 parts by weight of the lithium cobalt-based oxide.

11. The composite positive active material of claim 1, wherein the lithium cobalt-based oxide is in a form of small particles, large particles, or a mixture of small particles and large particles.

12. The composite positive active material of claim 11, wherein the lithium cobalt-based oxide comprises the mixture of the small particles and the large particles and a size of each of the large particles is about 10 μm to about 20 μm, and a size of each of the small particles is about 3 μm to about 6 μm.

13. The composite positive active material of claim 11, wherein the lithium cobalt-based oxide comprises the mixture of the small particles and the large particles and a mixing weight ratio of the large particles and the small particles is 7:3 to 9:1 in the mixture of the large particles and the small particles.

14. A method of preparing a composite positive active material for a lithium secondary battery, the method comprising:
mixing a lithium cobalt-based oxide, a titanium precursor, and cobalt hydroxide to obtain a first precursor mixture;
performing a primary heat-treatment on the first precursor mixture to prepare a product of the primary heat-treatment;
mixing the product of the primary heat-treatment and a zirconium precursor to obtain a second precursor mixture; and
heat-treating the second precursor mixture to prepare the composite positive active material of claim 1.

15. The method of claim 14, wherein an amount of the cobalt hydroxide is 1 part by weight to 3 parts by weight with respect to 100 parts by weight of the lithium cobalt-based oxide.

16. The method of claim 14, wherein an amount of the zirconium precursor is 0.2 parts by weight to 0.54 parts by weight with respect to 100 parts by weight of the lithium cobalt-based oxide.

17. The method of claim 14, wherein the zirconium precursor is zirconium oxide, and the titanium precursor is at least one of titanium hydroxide, titanium chloride, titanium sulfate, or titanium oxide.

18. The method of claim 14, wherein the primary heat-treatment of the first precursor mixture is performed at 850° C. to 980° C.

19. The method claim 14, wherein the heat-treatment of the second precursor mixture is performed at 750° C. to 900° C.

20. A lithium secondary battery comprising:
a positive electrode comprising the composite positive active material of claim 1;
a negative electrode; and
an electrolyte therebetween.
